(19) United States
(12) Patent Application Publication
(10) Pub. No.: US 2026/0231932 A1
(43) Pub. Date: Aug. 13, 2026

(54) ANTIFUNGAL ABSORBENT DEODORDIZING INSERT

(71) Applicant: Cynthia Joy Cooper, Lowndesboro, AL (US)

(72) Inventor: Cynthia Joy Cooper, Lowndesboro, AL (US)

(21) Appl. No.: 19/048,441

(22) Filed: Feb. 7, 2025

(51) Int. Cl. A01N 25/34; A01N 25/12; A01N 43/50; A01P 3/00

(52) U.S. Cl. CPC A01N 25/34; A01N 25/12; A01N 43/50; A01P 3/00

(57) ABSTRACT

An anti-fungal, absorbent, and deodorizing insert for footwear is provided. The insert includes an outer container housing deodorizing material, one or more absorbent packets, and an anti-fungal container. The one or more absorbent packets house absorbent materials configured to remove moisture from the environment. The anti-fungal container houses one or more anti-fungal materials configured to mitigate fungal growth. In use the insert can be placed in an item of footwear, while not in use, to mitigate fungal growth, prevent moisture buildup and deodorize the item of footwear.

### BACKGROUND OF THE INVENTION

### Field of Endeavor

The present invention relates to moisture prevention, and more particularly, to an insert having anti-fungal, absorbing, and deodorizing properties.

### Background of Related Art

Fungal growth is driven by moisture in warm and dark conditions, making footwear an ideal environment for proliferation of fungi. Fungal growth in footwear can lead to health issues for a wearer such as fungal infections, and additionally, can cause malodorous conditions in the footwear. Currently, fungal sprays are utilized to destroy fungal growth in footwear. However, these sprays merely remediate the fungal growth without remedying underlying moisture issues, and additionally, can leave residue in footwear diminishing both functional and aesthetic qualities of the footwear. Additionally, inserts have been utilized to control humidity, fungal growth, or odor but not as a singular insert.

As can be seen, there is a need for an insert configured to remove moisture, remediate fungal growth, and provide deodorization.

### SUMMARY OF THE INVENTION

Aspects of the present invention include an anti-fungal, absorbent, and deodorizing insert for footwear. The insert of the present invention includes an inner container housing one or more anti-fungal materials, one or more sorbent packets each housing one or more absorbent materials, and an outer container housing the inner container, the one or more sorbent packets, and one or more deodorizing materials.

The one or more anti-fungal materials of the present invention can be a powder, such as 2% by weight Miconazole Nitrate, C₁₈H₁₄Cl₄N₂O·HNO₃. Preferably, 15 milligrams of 2% by weight Miconazole Nitrate can be disposed within the inner container for fungal mitigation. The one or more absorbent materials can be silica gel, calcium chloride, activated charcoal, bentonite clay, or other absorbents known to one of ordinary skill in the art. Preferably, a plurality of sorbent packets each containing 1 gram of silica can be utilized. The one or more deodorizing materials can be ground, granulated, crushed, pulverized, or otherwise milled, lavender flower petals. Preferably, 500 milligrams of ground, granulated, crushed, pulverized, or otherwise milled, lavender flower petals can be disposed within the outer container. The containers and/or packets of the present invention can be formed from one or more non-woven fabrics being porous, permeable, or semi-permeable. Additionally, the one or more non-woven fabrics can be biodegradable.

### BRIEF DESCRIPTION OF THE DRAWINGS

FIG. 1 is a schematic diagram of an anti-fungal, absorbent, and deodorizing insert, according to aspects of the present invention;

FIG. 2 is a diagram of an anti-fungal, absorbent, and deodorizing insert shown in use, according to aspects of the present invention; and

FIG. 3 is an exploded diagram of an anti-fungal, absorbent, and deodorizing insert showing compositions housed therein, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention is an insert comprised of a plurality of containers, each container enclosing one or more materials and/or a different one of the plurality of containers. The one or more materials of the present invention include compositions having one or more properties such as, anti-microbial, anti-fungal, desiccating (or absorbent), and/or deodorizing properties.

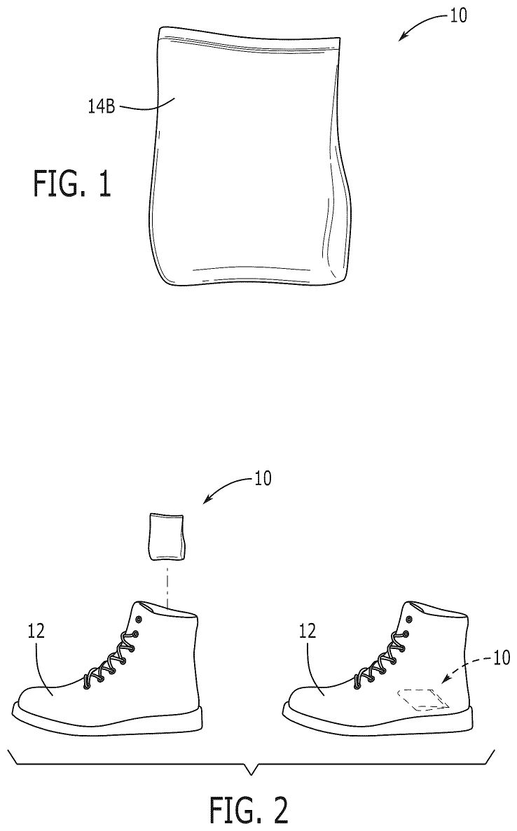

Referring now to FIGS. 1-3, aspects of an anti-fungal, absorbent, and deodorizing insert are illustrated. FIG. 1 illustrates an anti-fungal, absorbent, and deodorizing insert 10 including an outer container 14B housing one or more additional containers, and/or one or more materials having one or more properties such as anti-microbial, anti-fungal, desiccating (or absorbent), and/or deodorizing properties. In embodiments, insert 10 can be placed on, or in, one or more apparel items, such as shoes 12, where the one or more materials can remove moisture, and/or fungi, and provide deodorization of the one or more apparel items (as illustrated in FIG. 2).

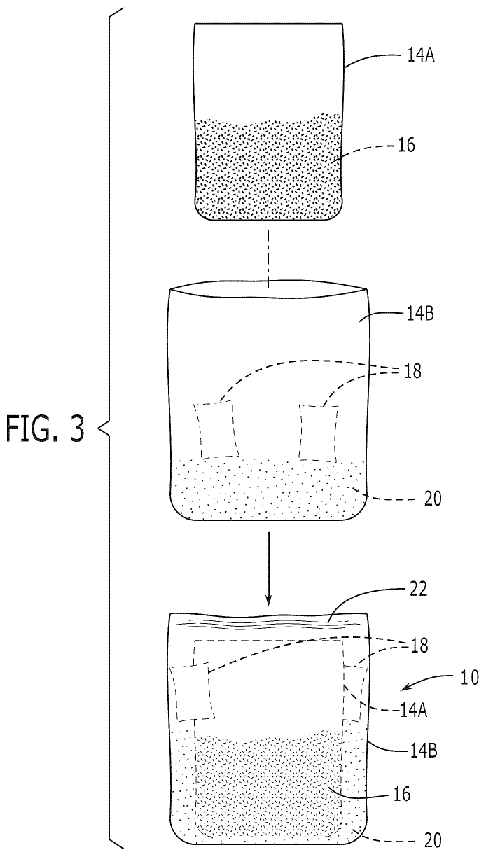

Referring now to FIG. 3, an exploded view of the anti-fungal, absorbent, and deodorizing insert 10, is illustrated. In embodiments, insert 10 can include a plurality of containers such as an anti-fungal container 14A, one or more absorbent containers 18, and outer container 14B. In embodiments, one or more plurality of containers can be formed from one or more non-woven fabrics, such as but not limited to Spunlace, or Spunbond, formed by bonding one or more fibers using heat and/or chemical processes. In embodiments, the one or more non-woven fabrics can be formed from one or more fibers that are biodegradable, such as but not limited to, viscose, polyester, cotton, polypropylene, etc. Finally, the plurality of containers can be porous, permeable, or semi-permeable.

In embodiments, anti-fungal container 14A can be an innermost container of insert 10. In embodiments, anti-fungal container 14A can be formed from one or more fabrics, such as non-woven fabrics. In embodiments, the one or more fabrics can be biodegradable. Additionally, anti-fungal container 14A can be take three dimensional shapes, such as prismatic shapes having a plurality of inner and outer surfaces. In an exemplary embodiment, anti-fungal container 14A can be a rectangular prismatic shape having a plurality of outer surfaces, a plurality of inner surfaces, and at least one interior space for housing one or more materials 16. Additionally, in the exemplary embodiment anti-fungal container 14A can be formed from non-woven, biodegradable fabric, and can have a height dimension of approximately 4 inches and a length dimension of approximately 3 inches.

In embodiments, the interior space of anti-fungal container 14A can be configured to house one or more materials 16. In embodiments, anti-fungal container 14A can have one or more materials 16 configured to mitigate, prevent, or treat, one or more fungal conditions. In embodiments, the one or more materials 16 can be a powder containing 2% (by weight) Miconazole Nitrate, C₁₈H₁₄Cl₄N₂O·HNO₃. In an exemplary embodiment, the one or more materials includes 15 milligrams of 2% (by weight) Miconazole Nitrate powder. Advantageously, Miconazole Nitrate can provide fungal protection.

Referring now to outer container 14B, outer container 14B can be formed from one or more fabrics, such as non-woven fabrics. In embodiments, the one or more fabrics can be biodegradable. Additionally, outer container 14B can be take three dimensional shapes, such as prismatic shapes having a plurality of inner and outer surfaces. In an exemplary embodiment, outer container 14B can be a rectangular prismatic shape having a plurality of outer surfaces, a plurality of inner surfaces, and at least one interior space for housing one or more of: anti-fungal container 14A, one or more desiccant packets 18, and one or more additional materials 20. Additionally, in the exemplary embodiment anti-fungal container 14A can be formed from non-woven, biodegradable fabric, and can have a height dimension of approximately 5 inches and a length dimension of approximately 4 inches.

In embodiments, the interior space of outer container 14B can be configured to house one or more of: anti-fungal container 14A, one or more desiccant packets 18, and one or more additional materials 20. In embodiments, the one or more desiccant packets 18 can have absorbent materials configured to remove moisture from an environment. In embodiments, the absorbent materials can be silica gel, calcium chloride, activated charcoal, bentonite clay, or other absorbents known to one of ordinary skill in the art. Additionally, outer container 14B can have one or more additional materials 20 configured to deodorize, or reduce malodorous smells. In embodiments, the one or more additional materials 20 can be organic raw grade lavender flower petals. In an exemplary embodiment, the one or more additional materials 20 can be 5 milligrams of organic raw grade lavender flowers. Advantageously, the one or more desiccants prevents moisture buildup, while the one or more additional materials deodorizes the environment.

In embodiments, insert 10 can be assembled by placing one or more components, such as one or more of: anti-fungal container 14A having one or more materials 16 therein, one or more desiccant packets 18, and/or one or more additional materials 20, into the interior space of outer container 14B. In embodiments, once the one or more components are placed in the interior space of outer container 20, the outer container can be sealed through a heating process to form insert 10. In use, insert 10 can be placed in an item of footwear, when not in use, providing one or more protections from fungal growth, moisture intrusion, and/or malodorous smells.

It should be understood, of course, that the foregoing relates to exemplary embodiments of the invention and that modifications may be made without departing from the spirit and scope of the invention as set forth in the following claims.

What is claimed is:

1. An insert, comprising:
an inner container housing one or more anti-fungal materials;
one or more sorbent packets each housing one or more absorbent materials; and
an outer container housing the inner container, the one or more sorbent packets, and one or more deodorizing materials.

2. The insert of claim 1, wherein the inner container and the outer container and made from one or more non-woven fabrics.

3. The insert of claim 2, wherein the one or more non-woven fabrics are biodegradable.

4. The insert of claim 1, wherein the one or more anti-fungal materials is a powder.

5. The insert of clam 3, wherein the powder is a powder having 2% by weight Miconazole Nitrate, C₁₈H₁₄Cl₄N₂O·HNO₃.

6. The insert of claim 1, wherein the one or more absorbent materials is one or more of:
silica gel, calcium chloride, activated charcoal, bentonite clay.

7. The insert of claim 1, wherein the one or more deodorizing materials is lavender flower pedals.
